(19) United States
(12) Patent Application Publication
(10) Pub. No.: US 2006/0047441 A1
(43) Pub. Date: Mar. 2, 2006

(54) Semantic gene organizer

(76) Inventors: Ramin Homayouni, Memphis, TN (US); Michael Waitsel Berry, Knoxville, TN (US); Kevin Erich Heinrich, Knoxville, TN (US); Lai Wei, Memphis, TN (US)

Correspondence Address: Steven M. Greenberg, Esq.;Christopher & Weisberg, P.A., Suite 2040, 200 East Las Olas Boulevard, Fort Lauderdale, FL, 33301, US

(21) Appl. No.: 11/215,635

(22) Filed: Aug. 30, 2005

Related U.S. Application Data
(60) Provisional application No. 60/605,734, filed on Aug. 31, 2004.

(51) Int. Cl. G06F 19/00

(52) U.S. Cl. 702/19; 702/20

(57) ABSTRACT

A semantic gene classification and annotation system, method and computer program can utilize Latent Semantic Indexing (LSI) to identify conceptually related genes based on textual information in biomedical literature, including MEDLINE citations. In addition, term weights calculated from the usage of the gene terms in and across gene documents can be used to automatically assign gene aliases and extend gene function annotation based upon primary biomedical literature.

### CROSS-REFERENCE TO RELATED APPLICATIONS

This patent application claims the benefit under 35 U.S.C. §119(e) of presently pending U.S. Provisional Patent Application 60/605,734, entitled SEMANTIC GENE ORGANIZER, filed on Aug. 31, 2004, the entire teachings of which are incorporated herein by reference.

### FIELD OF THE INVENTION

The present invention relates to genomic tools for examining gene functionality, and more particularly to automated methods for identifying gene relationships based upon a modeling of textual information relating to gene systems within gene documents.

### BACKGROUND OF THE INVENTION

Recent advances in genomic and proteomic technologies enable investigators to rapidly identify groups of genes that are coordinately regulated in different experimental conditions. Understanding the functional relationships and the biological effects of co-regulated genes, however, remains to be a time consuming and arduous task, requiring investigators to manually extract and assemble gene information from various biological databases. Yet, the ability to infer a gene regulatory network can provide a clear, precise and comprehensive logic to a vast number of parallel changes in gene expression. Such a gene regulatory network would, in turn, provide novel targets for medical intervention, including drug development. As such, efforts to develop data mining tools to extract gene information from biomedical literature recently have intensified.

As a first step in inferring gene regulatory networks, high-throughput automated methods are needed to rapidly validate genomic data and to identify groups of functionally related genes based on the published literature. Once groups of functionally related genes are identified, more computationally intensive text-mining methods such as natural language processing can be used to extract the nature of the relationships among genes. Automated information retrieval methods have been utilized for many years dating to the creation of digital libraries and the World Wide Web. Presently, three basic models for information retrieval are known to include the “Set Theoretic” or Boolean model, the algebraic or vector space model and the probabilistic model.

In the Boolean model, documents can be represented by sets of index terms and the documents can be retrieved in a binary fashion in that a document can be retrieved only if a query contains an index term associated with the document. In the vector space model, by comparison, documents can be represented by weighted index terms in a multidimensional space. In this regard, documents can be retrieved based upon the degree of similarity of the terms in the documents to the query—even if a query term does not appear in the document. Finally, in the probabilistic model, documents can be retrieved based upon the probability that the documents are determined to be relevant to a query. Notably, probabilistic models usually require further human interaction to improve retrieval performance.

For genomic applications, a number of set theoretic methods have been described in recent years that utilize functional gene annotation in public electronic databases such as the Medical Subject Heading (MeSH) index, LocusLink, Gene Ontology, and numerous protein-protein interaction or biochemical pathway databases such as the Kyoto Encyclopedia of Genes and Genomes. Each of the foregoing methods suffers in that each utilizes a binary criterion in indexing. The foregoing methods further suffer from the lack of specificity of controlled vocabularies. Consequently, since index terms are usually general, specific information regarding genes can be lost. Moreover, a confounding issue arises from the subjectivity of indexers, whereby different index terms may be assigned to the same citation by different indexers.

As an alternative approach, the biomedical literature can be queried directly rather than querying databases which reference a subset of the literature. As an example, PubGene is an automated tool for extracting gene relationships based upon the co-occurrence of gene symbols in MEDLINE abstracts. PubGene provides a rapid method to identify gene neighbors based on the biomedical literature. Nevertheless, on average PubGene identifies only half of the known gene relationships. This low recall primarily is due to inconsistencies in gene symbol usage in the literature. In the information retrieval arts, these problems are referred to as synonymy (multiple words having same meaning) and polysemy (words having multiple meanings). For instance, in addition to the official gene symbol, many genes contain aliases or synonyms that are preferred by different investigators. Moreover, oftentimes biochemical or cell biological studies refer to the gene product and not to the gene itself. Because of this inherent noise in the biological literature, relevant information may be overlooked by focusing on the gene symbol or any single word representation of the gene in the literature.

The co-occurrence methods of the known art can be least effective when extracting genomic relationship data for genes and proteins which are identified in experiments that have not been previously studied together. Ideally, genomic information retrieval methods classify genes based not only upon known or explicit relationships but also on latent or implicit relationships reported in the literature. Several tools such ARROWSMITH and PubMatrix exist that aid in extraction of implicit textual relationships between distinct sets of MEDLINE abstracts. Still, neither ARROWSMITH nor PubMatrix are suited for high-throughput studies. That is, both methods require considerable user effort and an a priori knowledge of the gene systems under investigation.

Recently, vector space modeling has been explored for gene clustering using functional information in annotated indices or MEDLINE abstracts. In vector space modeling, the semantic structure of a document can be represented as a vector in word space. In particular, the vectors can consist of weighted terms, which is a function of the frequency of the terms in and across the documents in the collection. Consequently, the degree of similarity between documents can be calculated by the cosine of the angle between document vectors. In contrast to and unlike Boolean techniques, in the vector space model as applied to genomic studies, relationships between genes may be extracted even if the gene names or aliases do not co-occur in abstracts. Accordingly, in the past few years it has been demonstrated that the expansion of gene annotation through vector space modeling results in a considerable improvement over the clustering of a subset of genes using a Boolean term matching method.

Notably, in U.S. Pat. No. 4,839,853 to Deerwester et al. for COMPUTER INFORMATION RETRIEVAL USING LATENT SEMANTIC STRUCTURE, a variant of the vector space model, referred to as “Latent Semantic Indexing” (LSI), is shown to improve information retrieval by a factor of thirty percent by using a classical factorization method known as singular value decomposition (SVD). Using SVD, a subspace can be created in which text documents are represented as vectors. The subspace may be regarded as a concept derived from the word usage patterns in the document. Hence, using LSI, relevant documents can be retrieved based on the degree of similarity in the word usage patterns in the documents.

The LSI model has been applied in several different applications including essay grading and standardized testing. For instance, in U.S. Pat. No. 6,356,864 to Foltz et al. for Methods for Analysis and Evaluation of the Semantic Content of a Writing Based on Vector Length, the LSI model has been applied to evaluating the quality of an essay. LSI methods also have been applied to problems in the biological and medical sciences. Recently it has been demonstrated that LSI techniques can be used to visualize themes and relationships from full-text articles in the scientific literature in order to understand the relations among nominal fields of science, to help editors with the assignment of appropriate reviewers, and to explore the scientific impact of scientific articles. Nevertheless, heretofore LSI type methods have not been applied to semantically organize gene relationships or to extract gene annotation and function from the biomedical literature, especially where gene references do not co-occur in the same document.

### SUMMARY OF THE INVENTION

The present invention is a semantic gene organization system, method and computer program product configured to address the foregoing deficiencies of gene classification and annotation tools. In particular, what is provided is a novel and non-obvious method, system and computer program product for identifying conceptually related genes based upon the textual content of gene documents. As specified herein, gene documents can include a collection of textual information obtained from public or private databases such as full-text online journal articles, abstract citations in MEDLINE, digital textbooks, and a variety of online gene centered indexes such as LocusLink (Gene) and OMIM databases. Notably, the method, system and apparatus of the invention can utilize Latent Semantic Indexing (LSI) to identify conceptually related genes based on the textual information in the gene documents.

In accordance with the present invention, a text mining tool can be provided which allows identification of relevant genes based upon keyword queries as well as gene-document queries. Most notably, the tool of the present invention can identify gene relationships even if the gene names or aliases do not co-occur in the same documents. Accordingly, the LSI-based system, method and apparatus of the present invention can provide a powerful tool to rapidly and accurately classify genes based on functional information in the biological literature.

The present invention further can include a knowledge base having a pairwise gene-gene similarity matrix. The knowledge base further can be analyzed utilizing correlative and non-correlative analyses including K-means clustering, nearest neighbor clustering, principle component analysis and the like. A knowledge base also can be provided which can include log-entropy weighted terms associated with each gene from the textual information in the gene-documents. The log-entropy weighted terms can be regarded as gene descriptors which provide specific functional information about genes.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a semantic gene organization system configured to identify conceptually related genes based upon the textual content of gene documents;

FIG. 2 is a schematic illustration of a semantic gene organization tool configured to respond to a query vector specifying a set of genes by identifying conceptual relations between the genes in the set based upon the textual content of gene documents in the system of FIG. 1; and,

FIG. 3 is a flow chart illustrating a process for identifying conceptually related genes based upon the textual content of gene documents in the semantic gene organization system of FIG. 1.

### DETAILED DESCRIPTION OF THE INVENTION

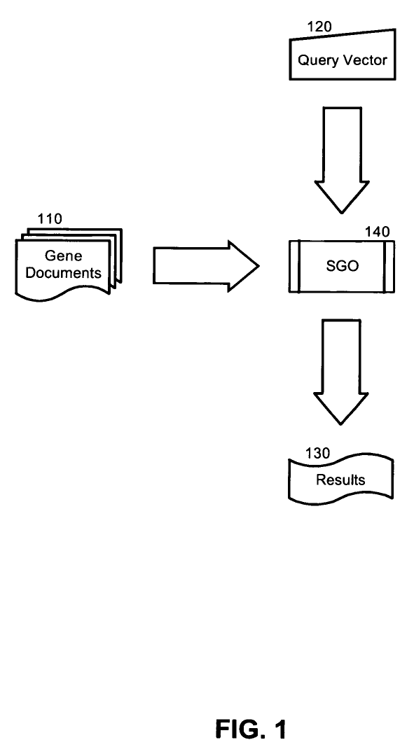

The present invention is a semantic gene organization system, method and apparatus. In accordance with the present invention, and as shown in FIG. 1, one or more gene documents 110 can be produced for selected genes by compiling textual information, for example titles and abstracts, for citations which are cross-referenced in any public or private database for the selected genes. A semantic gene organizer 140 can process the gene documents according to an LSI model to measure the similarity between gene documents based upon similar word usage patterns. Subsequently, responsive to a query vector 120 of one or more terms, a result set 130 of semantically relevant gene relationships can be produced.

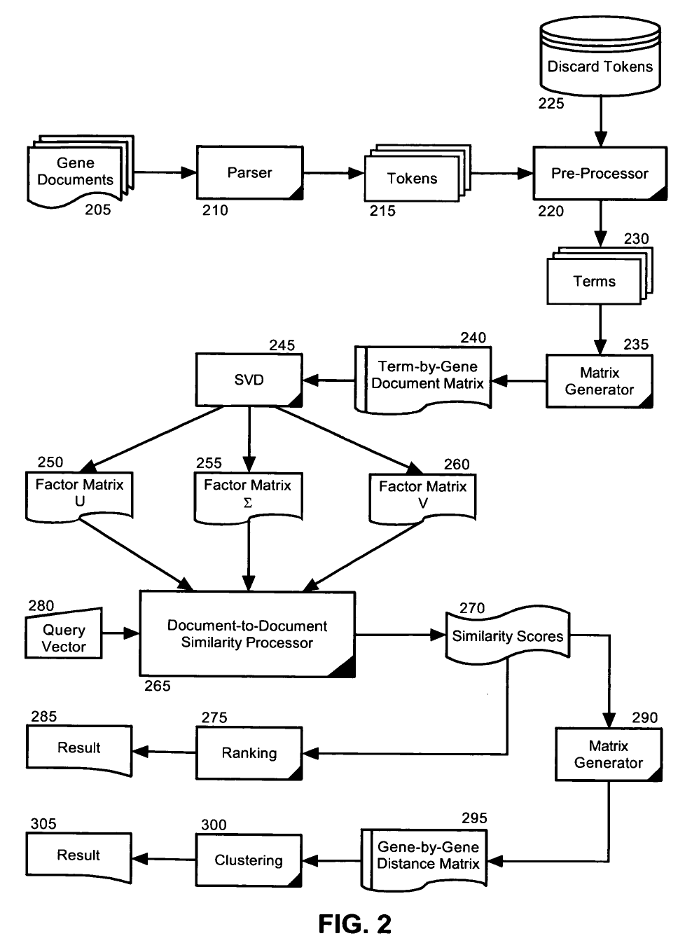

In further illustration, FIG. 2 is a flow chart illustrating a process for identifying conceptually related genes based upon the textual content of gene documents in the semantic gene organization system of FIG. 1. As shown in FIG. 2, gene-documents 205 can be passed to parser 210 which can parse the documents 205 into keywords (or tokens) 215. A pre-processor 220 can remove all punctuation (including hyphens), capitalization and semantically irrelevant words such as articles and prepositions from the tokens 215 using a data store listing of discardable tokens 225. The pre-processor 220 by virtue of removing the semantically irrelevant words can produce a set of processable terms 230.

A matrix generator 235 can create a term-by-gene matrix 240 where the entries of the matrix are the weighted frequencies, a nonnegative value used to describe the correlation between that term and the corresponding document. In general, each weight can be the product of a local and global component described below. Specifically, a log-entropy weighting scheme can be utilized. The local component lᵢⱼ and the global component gᵢ of the entropy weighting scheme can be computed as follows:

$${l}_{ij} = {log}_{2} ( 1 + {f}_{ij} )$$

$${g}_{i} = 1 + ( \frac{{\sum }_{j} ( {p}_{ij} {log}_{2} ( {p}_{ij} ) )}{{log}_{2} n} )$$

$${p}_{ij} = \frac{{f}_{ij}}{{\sum }_{j} {f}_{ij}}$$

where fᵢⱼ is the frequency of the ith term in the jth gene document, pᵢⱼ is the probability of the ith term occurring in the jth gene document, and n is the number of documents in the collection.

The weighted frequency for each token then can be computed by multiplying its local component by its global component. That is, the term-by-gene document matrix is defined as
M=└mᵢⱼ┘,
mᵢⱼ=lᵢⱼ*gᵢⱼ.
Once the m by n term-by-gene document matrix, M, has been created, a singular value decomposition process 245 can perform a truncated singular value decomposition of that matrix to create three factor matrices 250, 255, 260:
M=UΣV^{T},
where U is the m by r matrix of eigenvectors of MM^{T}, V^{T} is the r by n matrix of eigenvectors of M^{T}M, and Σ is the r by r diagonal matrix containing the r nonnegative singular values of M. The size of these factor matrices can be determined by r, the rank of the matrix M. By using only the first s columns of the three component submatrices 250, 255, 260, Mₛ can be computed as a rank-s approximation to M. In this case, s can be considerably smaller than the rank r.

A document-to-document similarity processor 265 can compute document-to-document similarity (assuming the document vectors V_{S} are scaled by the singular values Σ_{S})
M_{S}^{T}M_{S}=(V_{S}Σ_{S})(V_{S}Σ_{S})^{T}
and can be derived from the original formula for the rank-s approximation to M. Queries can be treated as pseudo-documents and can be computed as
q=q₀^{T}U_{S}Σ_{S}⁻¹
where q₀ is a query vector 280 of associated global term weights, constructed from the user's original input, and the s subscript denotes the first s columns of the corresponding matrix factor.

A given query vector 280 can be compared with all the gene-document vectors of the form dⱼ=Σ_{S}V_{S}^{T}eⱼ where eⱼ is the compatible vector of all zeros except the value 1 in position j. Relevance to the query is determined by a ranking of a similarity score, such as the cosine. To be more specific, the score of a gene-document dⱼ with respect to a query q can be defined by the cosine of the angle between the corresponding vectors in the LSI model. The similarity scores 270 can be computed as

$$cos {θ}_{j} = \frac{{d}_{j}^{T} ( {q}_{s} )}{{‖ {d}_{j} ‖}_{2} {‖ {q}_{s} ‖}_{2}} , j = 1 , … n ,$$

where qₛ denotes a scaled query vector (i.e., qₛ=Σₛq) and a ranking process 275 can rank the similarity scores 270 so that the gene-document vectors having the higher cosine values with the query vector 280 are deemed more relevant to the query.

Finally, search results 285 can be represented in either graphical or tabular formats. In addition, a self similarity matrix generator 290 can create a gene-by-gene distance matrix 295 where the entries describe the correlation between genes based on gene documents 205. Specifically, a self-similarity matrix, S, can be constructed by computing the cosine of the angle between gene document vectors. That is, S[i,j]=cos(gᵢ, gⱼ), where gᵢ and gⱼ represent gene documents i and j, respectively. Conversely, a distance matrix, D, is formed by subtracting each element of S from 1. That is, D[i,j]=1−S[i,j]. The distance values in the gene-by-gene matrix 295 can be used for further mathematical analysis in clustering process 300 to cluster genes to produce a result 305 based on conceptual relationships derived from the textual information in gene documents 205.

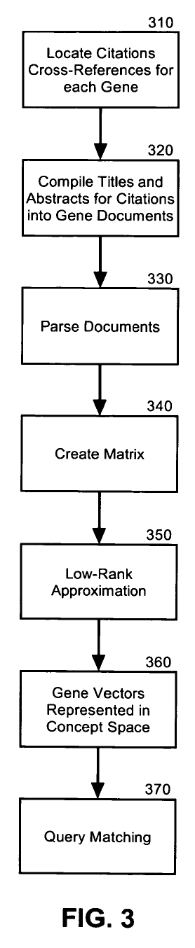

FIG. 3 is a flow chart illustrating a process for identifying conceptually related genes based upon the textual content of gene documents in the semantic gene organization system of FIG. 1. Beginning first in block 310, citations can be located which are cross-referenced in biotechnical databases such as LocusLink. For example, the cross-references can include each of human, mouse and rat entries for a specific gene. In block 320 the titles and abstracts for the located citations can be compiled into corresponding gene documents. In block 330, the gene-documents can be assembled and parsed into a dictionary of terms (tokens) and weighted frequencies that are required for the term-by-gene document (sparse) matrix. In effect, each gene-document can be viewed as a bag of words upon which operations can be performed.

In block 340, a term-by-gene matrix can be created. In this regard, in constructing the matrix, a log-entropy weighing scheme can be utilized to decrease the weight of high-frequency words while giving distinguishing words higher weight. In addition, restrictions on the global and/or document term frequencies can be imposed to control the size of the dictionary. For example, all words which occurred less than twice in one gene-document and in less than two gene-documents need not be included in the term-by-gene document matrix. The log entropy values of all terms in the gene document can be used to define specific gene descriptors. For example, the top weighted terms for each gene, given the gene document textual content, can be used to assign new gene aliases or to extract very specific biological function or disease information pertaining to genes. In this regard, term weights can be used to extend gene function annotations.

In blocks 350 and 360, term and document vectors for the LSI model can be generated by truncating the SVD of the term-by-gene document matrix to s factors (i.e., only s columns of the orthogonal matrices U and V are used). Thus, LSI produces a rank-reduced space in which to compare two gene-documents at different conceptual levels. In practice, the maximum number of factors is limited by the number of documents in the collection. Fewer factors may be used for broad (more conceptual) comparisons, whereas a larger number of factors may be used for specific (more literal) comparisons.

In block 370, query vectors can be generated by the user and may be formed according to two types of queries: 1) Keyword query, which may consist of any number of manually selected terms; 2) gene document query, which consists of all textual information in the gene document for the given gene. A pseudo gene document vector can be created by using the terms in the keyword query or accession number query for comparisons with the other gene document vectors in the collection. Since a gene document query vector consists of all of the textual information in the document, more accurate relationships can be identified than a vector consisting of a few keywords. Relevance to the query term can be determined by ranking a similarity score, defined by the cosine of the vector angles between the query and the gene-documents in the collection. Consequently, a ranked list of genes can be produced based upon the angle of the gene-abstract documents and the query vectors.

The method of the present invention can be realized in hardware, software, or a combination of hardware and software. An implementation of the method of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the claims of the invention, rather than to the foregoing specification, as indicating the scope of the invention.

We claim:

1. A sementic gene organization method comprising:
producing at least one gene document for a plurality of selected genes by compiling textual information for citations which are cross-referenced in a database for said selected genes;
processing said gene documents according to a latent semantic indexing (LSI) model to measure similarities between gene documents based upon similar word usage patterns; and,
parsing said gene documents to produce a result set of semantically relevant gene relationships responsive to receiving a query vector of at least one term.

2. The method of claim 1, wherein said producing at least one gene document for a plurality of selected genes by compiling textual information for citations which are cross-referenced in a database for said selected genes, further comprises:
assembling and parsing said textual information into a dictionary of terms and weighted frequencies; and,
generating a term-by-gene matrix with said dictionary of terms.

3. The method of claim 2, wherein said assembling and parsing said textual information into a dictionary of terms and weighted frequencies, further comprises imposing restrictions upon term frequencies in said dictionary to control dictionary size.

4. The method of claim 2, wherein said generating a term-by-gene matrix with said dictionary of terms, further comprises applying to said term-by-gene matrix a weighting to decrease weights of high-frequency terms while giving distinguishing terms higher weight.

5. The method of claim 4, wherein said applying to said matrix weighting to decrease weights of high-frequency terms while giving distinguishing terms higher weight, comprises using values of said terms to define specific gene descriptors to extend gene function annotations.

6. The method of claim 1, wherein said processing said gene documents according to an LSI model to measure similarities between gene documents based upon similar word usage patterns, comprises generating term and document vectors for said LSI model by truncating a singular value decomposition (SVD) of said term-by-gene document matrix to s factors to produce a rank-reduced space in which to compare two gene-documents at different conceptual levels.

7. The method of claim 1, wherein said parsing said gene documents to produce a result set of semantically relevant gene relationships responsive to receiving a query vector of at least one term, comprises:
determining a relevance to said at least one term by ranking a similarity score, defined by a cosine of a vector angle between said query vector and said gene-documents; and,
generating a ranked list of genes based upon an angle of said gene documents and said query vector.

8. The method of claim 1, further comprising producing said query vector according to one of a keyword query and a gene document query.

9. A semantic gene organization data processing system comprising:
a term-by-gene matrix generator configured to generate a term-by-gene document matrix based upon terms identified within gene documents;
singular value decomposition (SVD) logic enabled to generate a plurality of factor matrices based upon said term-by-gene document matrix; and,
a document-to-document similarity processor having a configuration to receive said factor matrices and to generate one of similarity and distance scores based upon a received query vector to produce results for said query vector.

10. The system of claim 9, further comprising a parser coupled to a pre-processor enabled to identify said terms within said gene documents.

11. The system of claim 9, further comprising ranking logic enabled to rank said results for said query vector.

12. The system of claim 9, further comprising clustering logic enabled to cluster said results for said query vector based upon a gene-by-gene distance matrix produced by said matrix generator.

13. A computer program product comprising a computer usable medium having computer usable program code for sementic gene organization, said computer program product including:
computer usable program code for producing at least one gene document for a plurality of selected genes by compiling textual information for citations which are cross-referenced in a database for said selected genes;
computer usable program code for processing said the gene documents according to a latent semantic indexing (LSI) model to measure similarities between gene documents based upon similar word usage patterns; and,
computer usable program code for parsing said gene documents to produce a result set of semantically relevant gene relationships responsive to receiving a query vector of at least one term.

14. The computer program product of claim 13, wherein said computer usable program code for producing at least one gene document for a plurality of selected genes by compiling textual information for citations which are cross-referenced in a database for said selected genes, further comprises:
computer usable program code for assembling and parsing said textual information into a dictionary of terms and weighted frequencies; and,
computer usable program code for generating a term-by-gene matrix with said dictionary of terms.

15. The computer program product of claim 14, wherein said computer usable program code for assembling and parsing said textual information into a dictionary of terms and weighted frequencies, further comprises computer usable program code for imposing restrictions upon term frequencies in said dictionary to control dictionary size.

16. The computer program product of claim 14, wherein said computer usable program code for generating a term-by-gene matrix with said dictionary of terms, further comprises computer usable program code for applying a weighting to decrease weights of high-frequency terms while giving distinguishing terms higher weight.

17. The computer program product of claim 16, wherein said computer usable program code for applying to said matrix a weighting to decrease weights of high-frequency terms while giving distinguishing terms higher weight, comprises computer usable program code for using weighted values of said terms to define specific gene descriptors to extend gene function annotations.

18. The computer program product of claim 13, wherein said computer usable program code for processing said gene documents according to an LSI model to measure similarities between gene documents based upon similar word usage patterns, comprises computer usable program code for generating term and document vectors for said LSI model by truncating a singular value decomposition (SVD) of said term-by-gene document matrix to s factors to produce a rank-reduced space in which to compare two gene-documents at different conceptual levels.

19. The computer program product of claim 13, wherein said computer usable program code for parsing said gene documents to produce a result set of semantically relevant gene relationships responsive to receiving a query vector of at least one term, comprises:
computer usable program code for determining a relevance to said at least one term by ranking a similarity score, defined by a cosine of a vector angle between a query vector and gene-document vectors; and,
computer usable program code for determining a relevance to said at least one term by ranking a distance score, defined by 1 minus the cosine of a vector angle between said query vector and said gene-document vectors; and,
computer usable program code for generating a ranked list of genes based upon an angle of said gene documents and said query vector.

20. The computer program product of claim 13, further comprising computer usable program code for producing said query vector according to one of a keyword query and a gene document query.
